(19) United States
(12) Patent Application Publication
(10) Pub. No.: US 2023/0169796 A1
(43) Pub. Date: Jun. 1, 2023

(54) IMAGE ANALYSIS METHOD AND IMAGE ANALYSIS DEVICE USING THE SAME

(71) Applicant: INDUSTRIAL TECHNOLOGY RESEARCH INSTITUTE, Hsinchu (TW)

(72) Inventors: Sanket Nagnath YERULE, Pune (IN); Wei-Cheng SUN, Kaohsiung City (TW); Chung-Wei HSIEH, Erlin Township (TW); Ting-Wei FAN, Taoyuan City (TW)

(73) Assignee: INDUSTRIAL TECHNOLOGY RESEARCH INSTITUTE, Hsinchu (TW)

(21) Appl. No.: 17/562,705

(22) Filed: Dec. 27, 2021

(30) Foreign Application Priority Data
Nov. 26, 2021 (TW) 110144217

(51) Int. Cl. G06V 40/20; G06V 20/00; G06T 7/246

(52) U.S. Cl. CPC G06V 40/23; G06V 20/35; G06T 7/251; G06T 2207/30196; G06T 2207/30221

(57) ABSTRACT

An image analysis method includes the flowing steps. Firstly, an image stream is received. Then, a to-be-analyzed frame of the image stream is analyzed to obtain a scene type of the to-be-analyzed frame. Then, whether the scene type of the to-be-analyzed frame is a classification of needing posture analysis is determined. Then, a human body posture of a human body image of the to-be-analyzed frame is obtained when the scene type of the to-be-analyzed frame is the classification of needing posture analysis. Then, an event type of the to-be-analyzed frame according to the scene type and the human body posture is determined.

This application claims the benefit of Taiwan application Serial No. 110144217, filed Nov. 26, 2021, the subject matter of which is incorporated herein by reference.

### TECHNICAL FIELD

The disclosure relates in general to an image analysis method and image analysis device using the same.

### BACKGROUND

The development of wireless networks or other environmental reasons (such as COVID-19 epidemic) usually changes the model of people participating in sports events. Most people turn to watch the game on-line, and thus physical game (or match) has changed from full cheering to a small number of spectators or even no spectators. Therefore, in order to cope with this changing trend, it is one of the important issues faced by the industry in this technical field to submit an image analysis method for image stream of game.

### SUMMARY

According to an embodiment, an image analysis method is provided. The image analysis method includes receiving an image stream; analyzing a to-be-analyzed frame of the image stream to obtain a scene type of the to-be-analyzed frame; determining whether the scene type of the to-be-analyzed frame is a classification of needing posture analysis; obtaining a human body posture of a human body image of the to-be-analyzed frame when the scene type of the to-be-analyzed frame is the classification of needing posture analysis; and determining an event type of the to-be-analyzed frame according to the scene type and the human body posture.

According to another embodiment, an image analysis device is provided. The image analysis device includes a scene analysis unit, a posture analysis unit and an event analysis unit. The scene analysis unit is configured to receive an image stream and analyze a to-be-analyzed frame of the image stream to obtain a scene type of the to-be-analyzed frame and determine whether the scene type of the to-be-analyzed frame is a classification of needing posture analysis. The posture analysis unit is configured to obtain a human body posture of a human body image of the to-be-analyzed frame when the scene type of the to-be-analyzed frame is the classification of needing posture analysis. The event analysis unit is configured to determine an event type of the to-be-analyzed frame according to the scene type and the human body posture.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 shows a schematic diagram of a functional block of an image analysis device according to an embodiment of the present disclosure;

FIG. 2 shows a flowchart of the image analysis method of the image analysis device of FIG. 1; and

FIGS. 3A to 3D show schematic diagrams of several to-be-analyzed frames of the image stream according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

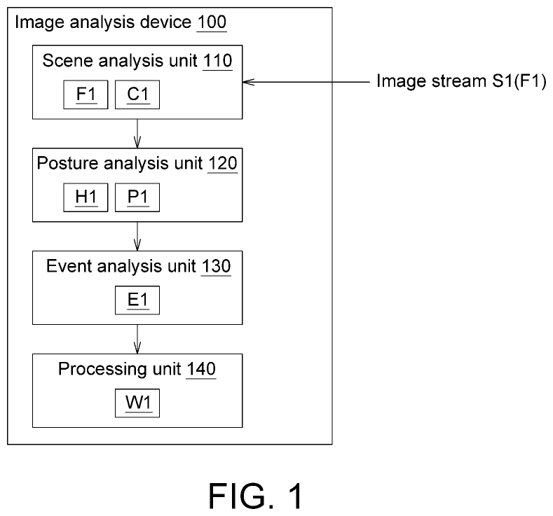

Referring to FIG. 1, FIG. 1 shows a schematic diagram of a functional block of an image analysis device 100 according to an embodiment of the present disclosure. The image analysis device 100 is, for example, a cloud server, a notebook computer, a desktop computer, a tablet computer, a communication device (such as a mobile phone), etc.

The image analysis device 100 includes a scene analysis unit 110, a posture analysis unit 120, an event analysis unit 130, and a processing unit (or processor) 140. The scene analysis unit 110 is configured to receive an image stream S1 and analyzing a to-be-analyzed frame F1 of the image stream S1 to obtain a scene type C1 of the to-be-analyzed frame F1, and determine whether the scene type C1 of the to-be-analyzed frame F1 is “classification of needing posture analysis”. The posture analysis unit 120 is configured to obtain a human body posture P1 in a human body image H1 of the to-be-analyzed frame F1 when the scene type C1 of the to-be-analyzed frame F1 is the “classification of needing posture analysis”. The event analysis unit 130 is configured to determine the event type E1 of the to-be-analyzed frame F1 according to the scene type C1 and the human body posture P1. As a result, the image analysis device 100 could automatically analyze to-be-analyzed frame F1 to determine (or output) the event type E1, without the need for additional manual determining and processing. In addition, after obtaining the event type E1, the image analysis device 100 could perform corresponding steps (or action), such as inserting a virtual advertisement and/or storing a frame (or recording), wherein the processing unit 140 further could post-produce the stored frame into a specific action movie (e.g. pitching, swinging, catching) and/or game highlights, etc. and/or analyze game (or race) data (e.g., ball speed analysis) based on the stored frame.

In an embodiment, the scene analysis unit 110 is configured to determine whether the scene type C1 of the to-be-analyzed frame F1 is the “classification of needing posture analysis” according to a corresponding relationship of the scene type C1 and the posture analysis.

In an embodiment, the posture analysis unit 120 is further configured to obtain the whole body skeleton characteristic of the human body image H1, analyze a number of the to-be-analyzed frames F1 to obtain a skeleton movement of the whole body skeleton characteristic, and obtain the human body posture P1 of the human body image H1 according to the skeleton movement. In an embodiment, the human body posture P1 is, for example, the whole body posture of the human body image H1.

In an embodiment, the processing unit 140 is configured to perform an event operation W1 corresponding to the event type E1 according to the corresponding relationship between the event type E1 and the event operation W1. The corresponding relationship is, for example, pre-stored in a storage unit (not shown), wherein the storage unit could be disposed inside or outside the processing unit 140.

The image analysis device 100 of the embodiment of the present disclosure could be applied to the analysis of the image stream of a baseball game. In the baseball game, the scene type C1 includes, for example, “classification of needing posture analysis” and “classification of not needing posture analysis”, wherein the “classification of not needing posture analysis” includes, for example, a scene having high viewer attention (e.g., a frame having high extent of excitement) such as “outfield”, “pitcher-batter”, “infield”, etc., and “classification of not needing posture analysis”, for example, is a scene having low viewer attention (e.g., a frame having low extent of excitement) such as “panorama of infield and outfield” (offensive-and-defensive exchange) . . . etc. The human body image H1 includes, for example, “pitcher”, “batter (or hitter)”, “outfielder”, “runner” . . . etc. The human body posture P1 includes, for example, the actions performed by the human body image H1, such as standing, clasping palms, striding, pitching, running, raising both hands, swinging, catching a ball, and any other actions that players would make on a baseball field. The event type E1 includes, for example, “pitching preparation”, “pitching”, “hitting preparation”, “strike/hit”, “home run”, “catch-out”, “offensive-and-defensive exchange” . . . etc. The event operation W1 includes, for example, “insert virtual advertisement” and/or “saving frame (or screen)” (or video recording) . . . etc.

In case of the baseball game, the corresponding relationship among the scene type C1, the human body image H1, the human body posture P1, the event type E1 and the event operation W1 is shown in the following TABLE 1. The corresponding relationship could be preset and stored in the storage unit in advance. However, the corresponding relationship among the scene type C1, the human body image H1, the human body posture P1, the event type E1 and the event operation W1 in the embodiment of the present disclosure is not limited by TABLE 1, and it may be other forms of corresponding relationship. In addition, the number of groups of the corresponding relationship is not limited to eight in TABLE 1, and the actual number of groups of the corresponding relationship could be increased or decreased depending on the actual application.

| | | human body | human body | event | event |
|---|---|---|---|---|---|
| # | scene type C1 | image H1 | posture P1 | type E1 | operation W1 |
| 1 | pitcher-batter | pitcher | walking | pitching | insert virtual |
| | | | | preparation | advertisement |
| 2 | pitcher-batter | pitcher | standing, | pitching | saving frame |
| | | | clasping palms, | | |
| | | | striding, | | |
| | | | pitching | | |
| 3 | pitcher-batter | batter | walk | hitting | inserting virtual |
| | | | | preparation | advertisement |
| 4 | pitcher-batter | batter | raising both | batting | saving frame |
| | | | hands, swinging | | |
| 5 | outfield | outfielder | run, stand | home run | saving frame |
| | | | | | and/or inserting |
| | | | | | virtual |
| | | | | | advertisement |
| 6 | outfield | outfielder | catching | catch-out | saving frame |
| 7 | panorama of | none (no | none (no | offensive-and- | inserting virtual |
| | infield and | posture | posture | defensive | advertisement |
| | outfield | analysis | analysis | exchange | |
| | | required) | required) | | |
| 8 | infield | runner | running | runner | saving frame |

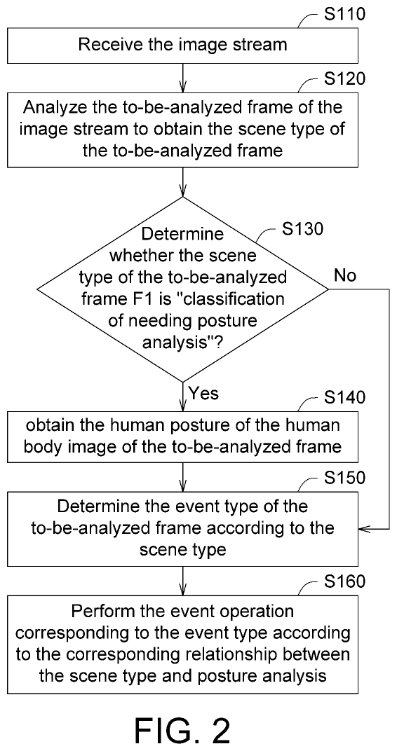

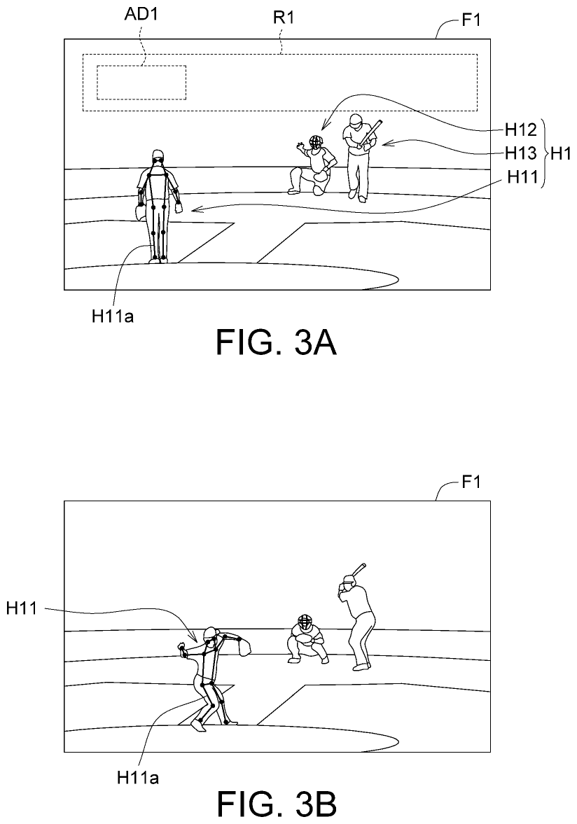

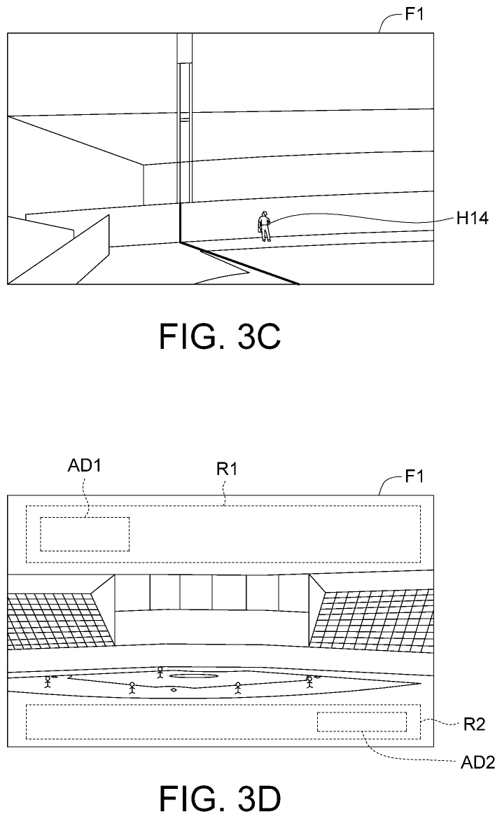

Furthermore, the image analysis method of the image analysis device 100 is further described with FIGS. 2 and 3A to 3D. FIG. 2 shows a flowchart of the image analysis method of the image analysis device 100 of FIG. 1, and FIGS. 3A to 3D show schematic diagrams of several to-be-analyzed frames F1 of the image stream S1 according to an embodiment of the present disclosure. The to-be-analyzed frames F1 in FIGS. 3A to 3D correspond to the corresponding relationships #1, #2, #5, and #7 in TABLE 1, respectively.

The following is a description of the to-be-analyzed frame F1 in FIG. 3A.

In step S110, the scene analysis unit 110 receives the image stream S1 including the to-be-analyzed frame F1 shown in FIG. 3A.

In step S120, the scene analysis unit 110 analyzes at least one to-be-analyzed frame F1 of the image stream S1 (FIG. 3A only shows one to-be-analyzed frame F1) to obtain the scene type C1 of the to-be-analyzed frame F1. For example, the scene analysis unit 110 analyze, by using image analysis technology, the scene type C1 of the to-be-analyzed frame F1 in FIG. 3A and accordingly determine the scene type C1 belongs to the “pitcher-batter”.

In step S130, the scene analysis unit 110 determines whether the scene type C1 of the to-be-analyzed frame F1 is “classification of needing posture analysis”. If yes, the process proceeds to step S140; if not, the human body posture P1 of the human body image H1 does not need to be analyzed, and the process directly proceeds to step S150. For example, the scene analysis unit 110 determines that the scene type C1 (“pitcher-batter”) of the to-be-analyzed screen F1 in FIG. 3A belongs to the “classification of needing posture analysis”, and the process proceeds to step S140.

The scene analysis unit 110 could determine whether the scene type C1 of the to-be-analyzed frame F1 is “posture analysis type” according to the corresponding relationship between the scene type C1 and the posture analysis. For example, as shown in the corresponding relationship #1 in TABLE 1, “pitcher-batter” belongs to the “classification of needing posture analysis”, and as shown in the corresponding relationship #7 in TABLE 1, if the scene type C1 of the to-be-analyzed frame F1 is “panorama of infield and outfield” (offensive-and-defensive exchange), and it belongs to “classification of not needing posture analysis”.

In step S140, the posture analysis unit 120 obtains the human body posture P1 of the human body image H1 of the to-be-analyzed frame F1.

The human body posture P1 is, for example, the whole body posture of the human body image H1. In detail, the posture analysis unit 120 could obtain, by using image analysis technology, the human body image H1 of each to-be-analyzed frame F1, for example, the human body images H11 to H13 shown in FIG. 3A. The posture analysis unit 120 determines, by using image analysis technology, the human body image H11 is a pitcher, the human body image H12 is a catcher and the human body image H13 is batter according to the relative positional relationship and/or image characteristics of the human body images H11 to H13 of the to-be-analyzed frame F1. Then, the posture analysis unit 120 obtains the whole body skeleton characteristic H11a of the human body image H11. The posture analysis unit 120 analyzes the whole body skeleton characteristic H11a of the human body image H1 of the to-be-analyzed frame F1 to obtain the skeleton movement of the human body image H11, and accordingly determines the human body posture P1 of the human body image H11. As shown in FIG. 3A, the posture analysis unit 120 determines the result of the human body image H11 is “walking” posture by analyzing the whole body skeleton characteristic H11a of the human body image H11 (e.g., pitcher).

As shown in FIG. 3A, the whole body skeleton characteristic H11a includes, for example, several feature points, such as human body joint points. The posture analysis unit 120 analyzes the relative position relationship of the feature points of the human body image, and could determine the skeleton movement (posture) of the human body image.

In step S150, the event analysis unit 130 determines the event type E1 of the to-be-analyzed frame F1 according to the scene type C1 and the human body posture P1. For example, the event analysis unit 130 determines the event type E1 of the to-be-analyzed frame F1 according to “pitcher-batter” (scene type C1) and “walking” (human body posture P1). The event analysis unit 130 could determine the result of the event type E1 of the to-be-analyzed frame F1 is “pitching preparation” according to the corresponding relationship #1 in TABLE 1.

In S160, after the event type E1 is generated, the processing unit 140 could perform the event operation W1 corresponding to the event type E1 according to TABLE 1. For example, as shown in FIG. 3A, the processing unit 140 inserts a virtual advertisement AD1 at least one portion of an advertising area R1 in the to-be-analyzed frame F1 according to the event type (for example, “pitching preparation”) of the corresponding relationship #1 in TABLE 1. The advertising area R1 is, for example, a blank area other than the human body image H1. The virtual advertisement AD1 is, for example, a dynamic image or a static image, which could include symbol, text/wording, mark or other graphic composed of straight line, curved-line or a combination thereof. In addition, the virtual advertisement AD1 could include at least one color.

The following is a description of the to-be-analyzed frame F1 in FIG. 3B.

The scene analysis unit 110 analyzes at least one to-be-analyzed frame F1 (FIG. 3B only shows one to-be-analyzed frame F1) of the scene type C1, and accordingly determines the scene type C1 belongs to the “pitcher-batter” (step S120). The scene analysis unit 110 determines that the “pitcher-batter” (scenario type C1) belongs to the “classification of needing posture analysis” (step S130). The posture analysis unit 120 determines the human body posture P1 of the human body image H1 of the to-be-analyzed frame F1 is “standing, clasping palms, striding, pitching” (step S140). The event analysis unit 130 determines the event type E1 of the to-be-analyzed frame F1 according to “pitcher-batter” (scene type C1) and “standing, clasping palms, striding, pitching” (human body posture P1). For example, the event analysis unit 130 determines the event type E1 of the to-be-analyzed frame F1 is “pitching” according to the corresponding relationship #2 in TABLE 1. Similarly, as shown in FIG. 3B, the posture analysis unit 120 could determine the human body image H11 is “standing, clasping palms, striding, pitching” by analyzing the whole body skeleton characteristic of the to-be-analyzed frame F1 of the human body image H11 in FIG. 3B. When the event type E1 is generated (or output), the processing unit 140 performs the event operation W1 corresponding to “pitching”, that is, the “saving frame” according to the TABLE 1 corresponding relationship #2.

The following is a description of the to-be-analyzed frame F1 in FIG. 3C.

The scene analysis unit 110 analyzes at least one to-be-analyzed frame F1 (FIG. 3C only shows one to-be-analyzed frame F1) of the scene type C1, and accordingly determines that the scene type C1 belongs to “outfield” (step S120). The scene analysis unit 110 determines that the “outfield” (scene type C1) belongs to the “classification of needing posture analysis” (step S130). The posture analysis unit 120 determines the human body posture P1 of the human body image H14 of the to-be-analyzed frame F1 is “running, standing” (step S140). The event analysis unit 130 determines the event type E1 of the to-be-analyzed frame F1 according to “outfield” (scene type C1) and “running, standing” (human body posture P1). For example, the event analysis unit 130 determines the event type E1 of the to-be-analyzed frame F1 is “home run” according to the corresponding relationship #5 in TABLE 1. Similarly, as shown in FIG. 3C, the posture analysis unit 120 could determine the human body image H14 is “running, standing” by analyzing the body image H14 of the to-be-analyzed frame F1 in FIG. 3C. After the event type E1 is generated (or output), the processing unit 140 performs the event operation W1 corresponding to “home run”, namely “saving frame” and/or “inserting virtual advertisement” according to the corresponding relationship #5 in TABLE 1. Several consecutive to-be-analyzed frame F1 could construct into a dynamic image file (for example, video recording file).

The following is a description of the to-be-analyzed frame F1 in FIG. 3D.

The scene analysis unit 110 analyzes at least one to-be-analyzed frame F1 (FIG. 3D only shows one to-be-analyzed frame F1) of the scene type C1, and accordingly the scene type C1 belongs to the “panorama of infield and outfield” (step S120). The scene analysis unit 110 determines that the “panorama of infield and outfield” (scene type C1) belongs to the “classification of not needing posture analysis” (step S130). In this situation, the posture analysis unit 120 does not need to analyze the human body posture of the human body image of the to-be-analyzed frame F1. The event analysis unit 130 determines the event type E1 of the to-be-analyzed frame F1 according to the “panorama of infield and outfield” (scene type C1). For example, the event analysis unit 130 determines the event type E1 of the to-be-analyzed frame F1 is “offensive-and-defensive exchange” according to the corresponding relationship #7 in TABLE 1. Similarly, as shown in FIG. 3D, when the event type E1 is generated (or output), the processing unit 140 performs the event operation W1 corresponding to “offensive-and-defensive exchange” according to the corresponding relationship #7 in TABLE 1, that is, “inserting virtual advertisement”. For example, as shown in FIG. 3D, the processing unit 140 inserts the virtual advertisements AD1 and AD2 in at least one portion of the advertisement areas R1 and R2 of the to-be-analyzed frame F1 according to the event type (for example, “offensive-and-defensive exchange”) of the corresponding relationship #7 in TABLE 1. The advertising area R1 and/or the advertising area R2 are/is, for example, blank area, upper area and/or lower areas. The virtual advertisements AD1 and AD2 are, for example, dynamic image or static image, which could include symbol, text/wording, mark or other graphic composed of straight line, curved-line or a combination thereof. In addition, the virtual advertisement AD1 could include at least one color.

In the present embodiment, the image stream S1 includes several to-be-analyzed frames F1. The image analysis device 100 could sequentially analyze the to-be-analyzed frame F1, and generate or output the event type E1 corresponding to one or more of the to-be-analyzed frames F1. In addition, the image analysis device 100 could mark (or insert), by using image insertion/processing technology, the analysis/determination result (e.g., text/wording) of at least one of the corresponding event type E1, the human body posture P1 and scene type C1 in the advertising area and/or the corner area of each to-be-analyzed frame F1. For example, as shown in FIG. 3A, the texts such as “Scene Type: pitcher-batter”, “Human Body Posture: walking” and/or “Event Type: pitching preparation” in the advertisement area R1 of the to-be-analyzed frame F1. In addition, the analysis process in FIG. 2 could be performed simultaneously when the video stream S1 is played or live broadcast is performed, and the corresponding event operation W1 could be performed in real time in the to-be-analyzed frame F1 which are playing or played on live broadcast.

In summary, the embodiment of the present disclosure proposes an image analysis device that could determine the event type of the to-be-analyzed frame according to the scene type and the human body posture of at least one to-be-analyzed frame in the image stream. After obtaining the event type, the image analysis device accordingly could perform corresponding steps, such as inserting virtual advertisements and/or storing frames (or video recording). As a result, the image analysis device could automatically analyze at least one to-be-analyzed frame in the image stream without additional manual processing. Furthermore, through the image analysis method of this disclosed embodiment, even if the audience is watching the game online, the image analysis device could insert the virtual advertisement in an appropriate area of the to-be-analyzed frame without affecting the frame viewing, or/and for the to-be-analyzed frame having low extent of excitement, the image analysis device could store the to-be-analyzed frame for post-producing a short video and/or analyzing the event data.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. An image analysis method for a baseball game image stream, comprises:
receiving an image stream;
analyzing a to-be-analyzed frame of the image stream to obtain a scene type of the to-be-analyzed frame;
determining whether the scene type of the to-be-analyzed frame is a classification of needing posture analysis;
obtaining a human body posture of a human body image of the to-be-analyzed frame when the scene type of the to-be-analyzed frame is the classification of needing posture analysis; and
determining an event type of the to-be-analyzed frame according to the scene type and the human body posture.

2. The image analysis method according to claim 1, wherein in step of obtaining the human body posture of the human body image of the to-be-analyzed frame, the human body posture is a whole body posture of the human body image.

3. The image analysis method according to claim 1, wherein the step of obtaining the human body posture of the human body image of the to-be-analyzed frame comprises:
obtaining a whole body skeleton characteristic of the human body image;
analyzing the to-be-analyzed frame to obtain a skeleton movement of the whole body skeleton characteristic; and
obtaining the human body posture of the human body image according to the skeleton movement.

4. The image analysis method according to claim 1, wherein the step of determining whether the scene type of the to-be-analyzed frame is the classification of needing posture analysis comprises:
determining whether the scene type of the to-be-analyzed frame is the classification of needing posture analysis according to a corresponding relationship of the scene type and a posture analysis.

5. The image analysis method according to claim 1, further comprises:
performing an event operation corresponding to the event type according to the corresponding relationship of the event type and the event operation.

6. The image analysis method according to claim 5, further comprises:
storing the to-be-analyzed frame according to the corresponding relationship of the event type and the event operation.

7. The image analysis method according to claim 5, further comprises:
inserting a virtual advertisement in the to-be-analyzed frame according to the corresponding relationship of the event type and the event operation.

8. An image analysis device for a baseball game image stream, comprises:
a scene analysis unit configured to receive an image stream and analyze a to-be-analyzed frame of the image stream to obtain a scene type of the to-be-analyzed frame and determine whether the scene type of the to-be-analyzed frame is a classification of needing posture analysis;
a posture analysis unit configured to obtain a human body posture of a human body image of the to-be-analyzed frame when the scene type of the to-be-analyzed frame is the classification of needing posture analysis; and
an event analysis unit configured to determine an event type of the to-be-analyzed frame according to the scene type and the human body posture.

9. The image analysis device according to claim 8, wherein the human body posture is a whole body posture of the human body image.

10. The image analysis device according to claim 8, wherein the posture analysis unit is further configured to obtain a whole body skeleton characteristic of the human body image, analyze the to-be-analyzed frame to obtain a skeleton movement of the whole body skeleton characteristic, and obtain the human body posture of the human body image according to the skeleton movement.

11. The image analysis device according to claim 8, wherein the scene analysis unit is further configured to determine whether the scene type of the to-be-analyzed frame is the classification of needing posture analysis according to a corresponding relationship of the scene type and a posture analysis.

12. The image analysis device according to claim 8, further comprises:
a processing unit configured to perform an event operation corresponding to the event type according to a corresponding relationship of the event type and the event operation.

13. The image analysis device according to claim 12, wherein the processing unit is further configured to store the to-be-analyzed frame according to the corresponding relationship of the event type and the event operation.

14. The image analysis device according to claim 12, wherein the processing unit is further configured to insert a virtual advertisement in the to-be-analyzed frame according to the corresponding relationship of the event type and the event operation.
